(19) United States
(12) Patent Application Publication
(10) Pub. No.: US 2018/0345520 A1
(43) Pub. Date: Dec. 6, 2018

(54) METHOD FOR PROCESSING FOOD PRODUCTS AND FOOD PROCESSING SYSTEM WITH POSITION TRACKING

(71) Applicant: WEBER MASCHINENBAU GMBH BREIDENBACH, Breidenbach (DE)

(72) Inventors: Christoph ECKHARDT, Breidenbach (DE); Udo HALLENBERGER, Oberasphe/Muenchhausen (DE); Joachim SCHAUB, Hatzfeld-Reddighausen (DE)

(73) Assignee: WEBER MASCHINENBAU GMBH BREIDENBACH, Breidenbach (DE)

(21) Appl. No.: 15/995,891

(22) Filed: Jun. 1, 2018

(30) Foreign Application Priority Data
Jun. 1, 2017 (DE) 102017112137.4

(51) Int. Cl. B26D 7/30; B26D 7/32; G01G 15/02; B65B 25/06

(52) U.S. Cl. CPC B26D 7/30; B26D 7/325; B26D 7/0625; B65B 25/06; G01G 15/02

(57) ABSTRACT

The present disclosure relates to a method for processing food products, comprising the following steps: multi-track slicing of food products into individual food portions on a plurality of production tracks; detecting at least one feature of a food portion during and/or after slicing; multi-track conveying of the food portions on separate production tracks; moving the food portions 34 from a plurality of production tracks onto a reduced number of output tracks and/or moving them between different tracks and/or grouping them. According to the present disclosure, the position of the individual food portions is tracked by means of a controller, so that, for each food portion 16 which has been moved onto the output track, it will be known on which production track said food portion 16 has been produced. The disclosure further relates to a food processing system.

### CROSS-REFERENCE TO RELATED APPLICATIONS

This application claims foreign priority benefits under 35 U.S.C. § 119(a)-(d) to German patent application number DE 10 2017 112 137.4, filed Jun. 1, 2017, which is incorporated by reference in its entirety.

### TECHNICAL FIELD

The present disclosure relates to a method for processing food products and to a food processing system.

### BACKGROUND

The prior art discloses food processing systems, in which food slicing systems, in particular slicers with a rotating sickle knife or a circular knife revolving in a planetary mode, are combined with upstream and downstream systems, such as X-ray scanners, scales, conveyors and packaging machines.

Even minor erroneous portion weights of the product in question may be economically disadvantageous in the production of food products. If the portion weight exceeds the predetermined weight value for a specific packaging unit, a so-called give-away will be created, which is detrimental to profitability. If, however, the weight is lower than the predetermined weight by a certain value, the portions produced will no longer lie within the statutory framework, and can therefore not be sold.

Hence, provisions are made to optimize the accuracy of the weight of the food portions produced.

EP 1 982 806 B1 discloses that both an under-weight signal and a signal of an end-of-line scale are used for feedback controlling a single-track slicer.

Furthermore, the prior art aims at increasing the throughput of food processing systems. It is known to slice food products in parallel by means of a plurality of slicers, the slices from various tracks being combined so as to form portions, and these portions pass across an end-of-line scale, the signal of this end-of-line scale being used for adapting the slice thickness in a slicer.

In addition, a food processing system is known in the case of which the feedback control of a plurality of slicers during parallel slicing is adapted on the basis of the portion weight values determined on a common end-of-line scale. This, however, sets certain limits to the optimization of the portion weights, since all the slicers are feedback controlled on the basis of a common signal.

### SUMMARY

Therefore, it is an object of the present disclosure to provide a method for processing food products and a food processing system, which are adapted to be used not only for increasing the throughput and the productivity, but also for improving the accuracy of the portion weight of the food portions produced.

Therefore, the present disclosure provides a method for processing food products, comprising the steps of multi-track slicing of food products into individual food portions on a plurality of production tracks, detecting at least one feature of a food portion during and/or after slicing, multi-track conveying of the food portions on separate production tracks, and moving the food portions from a plurality of production tracks onto a reduced number of output tracks and/or moving them between different tracks and/or grouping them. According to the present disclosure, the position of the individual food portions is tracked by means of a controller, so that, for each food portion which has been moved onto the output track, it will be known on which production track said food portion has been produced. Hence, a trackability of the food portions is guaranteed, so that, if necessary, the operating behavior can be adapted and the feedback control can be adjusted on the production track on which the food portions have been processed. In this way, a precise optimization of the method can be accomplished.

According to an advantageous embodiment, a data set can be stored in a data memory of the controller for each food portion, the production track, on which the food portion has been produced, being identified in the data set. Furthermore, the food product, which has been sliced for the food portion, may be identified in the data set.

A food portion is in particular a group of food slices, which have been cut off from one or a plurality of food products, especially groups of sausage slices, cheese slices and/or ham slices.

The food slices of a food portion may be arranged such that they are stacked, shingled or positioned side-by-side. The food portion may consist exclusively of food slices, but it may also comprise an underlay paper or an underlay film or interleaver papers or interleaver films. As far as the food slices are arranged in a package, also this package can be regarded as part of the food portion.

The production track may comprise processing, handling and/or analysis apparatuses, through which the respective food portions are conveyed. In particular, the production track comprises at least one track of a food slicing apparatus, of a portioner, of a track-related scale, of a discharge apparatus, of a format completing device, of a portion aligner, of an infeed device, of a portion control indicator, of a transition conveyor, of a packaging machine and/or of a loading belt. The above-mentioned apparatuses and devices may each comprise conveyors or may comprise conveyors which are at least partially common to them. The conveyors used may especially be conveyor belts, carrier belts, transport rollers or single conveyors, such as transport movers.

The reduced number of output tracks comprises at least one output track and, in particular, only one output track.

According to an advantageous embodiment, the method comprises the step of monitoring the individual food portions by means of monitoring units, so that for each food portion moved onto the output track at least one characteristic feature of the food portion is known, and/or it is known which changes the food portion has undergone. The monitoring may be executed by sensors or by evaluating the control of actuators. By way of example, a sensor in the form of a camera, a scale or a scanner may be provided, by means of which characteristics of the food portions can be detected.

The characteristics of the food portion comprise its weight, its appearance, but also its position features, such as the positioning of the slices within the portion relative to one another and/or of the portion in a package or on a carrier.

In addition, the evaluation of the control of the actuators, such as a conveyor or a robot, may allow a trackability of the food portion.

The slicing of the food products is carried out in particular in a food slicing system, especially in a multi-track slicer comprising one or a plurality of rotating sickle knives or circular knives revolving in a planetary mode, or a plurality of single-track slicers comprising one rotating sickle knife or one circular knife revolving in a planetary mode.

According to an embodiment, the method further comprises the step of measuring the weight of each food portion on the output track with an end-of-line scale, and assigning the weight measured on the end-of-line scale to the respective production track on which the food portion in question has been sliced.

Hence, it is possible to assign the detected individual weights and/or the statistical weight values, such as average values or standard deviations, to the individual tracks of the multi-track slicing process.

By statistically evaluating the weights of the individual food portions, e.g., the average value of a specific batch size, comprising in particular more than 50, more than 100 or more than 1000 portions, a meaningful value concerning the accuracy and deviations of the portion weights can be calculated.

Taking this as a basis, the execution of the food processing method can be adapted, so as to reduce the percentage of food portions having an insufficient weight and food portions having an excessive weight, and so as to produce food portions having a weight as close as possible to the nominal weight.

In particular, the food portions are packed before their weight is determined by the end-of-line scale. The end-of-line scale determines the weight of the fully packed portion within the frame-work of a final check. To this end, a so-called FPV scale may be used, i.e., a scale that checks the food portions within the framework of the statutory provisions of the Fertigpackungsverordnung (FPV) (pre-packaging regulation).

The packaging of food portions may take place on the production tracks, or it may take place only on the output track upstream of the end-of-line scale, i.e., downstream of the transfer apparatus.

In particular, the food portions may be packed in a multi-track process. In this case, a plurality of food portions is conveyed side by side in packages, which are then closed. Packaging takes especially place in parallel on two, three, four, five, six or more than six tracks.

The packed food portions are then moved from the plurality of packaging tracks onto a reduced number of output tracks, advantageously onto one or two output tracks, which each have an end-of-line scale.

In particular, the moving of the food portions from a plurality of production tracks onto a reduced number of output tracks may take place in a controlled manner. The controlled sequence of feeding the food portions from the plurality of production tracks onto the at least one output track can thus be predetermined. The control information can be used for tracking the position of the food portions.

According to an advantageous embodiment, the slicing on the production tracks is separately feedback controlled, in particular by adapting, based on the measured weight of the food portions of the respective production tracks or based on values derived therefrom, the slice thickness during slicing. It follows that, if weight deviations are detected, the operation of the respective production tracks can be corrected precisely.

The feedback control of slicing on the production tracks is advantageously executed by approximating the actual weight, starting from a weight value that exceeds the target weight, to the target weight from above. In so doing, it is ensured that the actual weight will not be reduced to a value below the target weight or to a weight limit value slightly below the target weight.

In particular, a track-related average value of the weight is formed over a specific number of food portions. By tracking the position of the individual food portions, the weight value deter-mined on the at least one output track by the end-of-line scale can be assigned to a respective one of the production tracks. On the basis of the weight values assigned to a production track, a track-related average value may then be formed, advantageously over a specific batch size of more than 10, more than 100, more than 500 or more than 1000 food portions. If this average value is higher than a desired target value, the slicing on the production track in question can be adapted such that the target value will be reached more precisely.

According to an advantageous embodiment, the food portions are weighed within the framework of multi-track conveyance on a separate tracks with respective track-related scales. In particular, the food portions are conveyed on the individual production tracks across a respective track-related scale. The scales in question are, advantageously, throughput checkweighers, which are arranged downstream of the food slicing system. Also, the weight information detected in this way may be fed back in a manner related to the respective tracks for feedback control of multi-track slicing. The weight value of a food portion detected by the track-related scale is, advantageously, compared with the weight value of the same food portion on the end-of-line scale. This can be done on the basis of the tracking of the food portion by the controller. In this way, it can be detected whether the weight of a food portion has been changed by weight correction, or whether there is a malfunction of one of the track-related scales or of the end-of-line scale, an incorrect conveyance of a portion or of portions, or an inadmissible manipulation.

The tracking of the individual food portions from the end-of-line scale back to the production tracks especially allows a comparison between the track-related checkweighers and the at least one end-of-line scale. In particular, a malfunction of one of the scales can be detected in this way. Furthermore, the tare percentage of the package can be determined, i.e., the weight of the package and of possibly provided interleaver films or interleaver papers in relation to the food portion contained in the package.

In the case of deviations from the target weight, the weight of the portion can then be corrected immediately by cutting thinner or thicker individual slices or by changing the number of slices per portion. If the weight of the food portions is additionally determined on the output track by means of an end-of-line scale and fed back in a track-related manner, this feedback control can even be rendered much more precise.

In this way, an optimum weight value can be accomplished on each production track. This is primarily made possible by the fact that the food portions on the output track can be traced back to the production tracks.

According to an embodiment, the food portions are, within the framework of multi-track conveyance, arranged relative to one another in a format set, and, in so doing, food portions are transversely moved between the production tracks, the transverse moving being tracked by the controller. Hence, tracking of the position of the individual food portions is guaranteed in spite of such transverse moving.

In particular, the transfer moving may be carried out by a picker robot. A picker robot will here advantageously be a delta robot or a gantry robot by means of which at least one food portion can be gripped, moved and re-deposited. Moving takes here place in at least one direction deviating from the direction of the production tracks.

According to an advantageous embodiment, the weight of at least one erroneous-weight food portion is corrected, within the framework of multi-track conveyance, by adding or removing food slices. Whenever a weight correction for a food portion is executed, this weight correction will be stored in a data memory in a portion-related manner. In this way, it is possible to prevent the weight-corrected food portions from being included in the evaluation or the feedback control of the multi-track slicing process. Optionally, the weight-corrected food portions may be subjected to a separate evaluation. When it is statistically recorded that an increased number of weight corrections has been necessary due to one of the production tracks, information to this effect may be outputted either to an operator or to an error check routine.

Otherwise, the at least one weight-corrected food portion would distort the track-related weight values, and this would lead to errors in the feedback control or in the statistical evaluation. In particular, the addition or removal of food slices can be regarded as a disturbance variable in the control loop, which, however, can be eliminated by the above teaching.

According to an embodiment, the position of weight-corrected food portions can also be tracked up to the output track. The measured weight of the weight-corrected food portion may then also be subjected to statistical evaluation.

Weight correction is especially executed by a portion control indicator indicating for each food portion whether a manual addition or removal of slices has to be carried out. To this end, the cur-rent weight of the respective food portions produced can be detected and stored after the multi-track slicing process. Within the framework of multi-track conveyance, it can then be indicated how the respective food portions are to be corrected.

The weight correction of the individual food portions may take place during multi-track conveyance on the separate production tracks. The food portions may in this case still rest on a conveyor of the production track, or they may already have been placed into a package that is still open.

To this end, the position of the food portions on the production tracks is tracked, so that said position will be known to the controller. For the food portions located on the production track, it may then be indicated to an operator, whether, and if so how, said food portions have to be corrected. The operator will then add slices or remove slices, as indicated. According to an alternative embodiment, the addition or removal of individual slices may, however, also take place automatically, e.g., by a robot or a loader.

However, the weight-corrected food portions normally have a portion weight that is significantly higher than the target weight, so that they would corrupt the evaluation on the end-of-line scale.

If the corrected food portions were taken into account, the measured average value of the portion weight would have a higher value than the actual average value of the weight of the food portions produced by the food slicing system. Hence, the feedback control would take as a basis an excessively high average portion weight, and this would lead to a feedback control towards thinner slices, which, in turn, would result in the necessity of adding slices in the case of a higher number of food portions. It follows that, on the whole, this would lead to an instable control loop of the portion weight.

Making use of the tracking of the individual food portions according to the present disclosure, it can be guaranteed that weight-corrected food portions or other food portions having a weight that is much lower or much higher than the target weight will be tracked up to the end-of-line scale, where they will not be taken into consideration in the evaluation, but removed in particular from the statistics for average value determination.

According to an advantageous embodiment, the change of an erroneous-weight food portion during weight correction is detected by sensors. In particular, the detection by sensors may be executed through optical monitoring or by a scale. The detection by sensors may take place by comparing the weight of the erroneous-weight food portion, which is determined by the track-related scale, and the weight of this food portion after the weight correction, which is determined by the end-of-line scale, in particular by a subtraction of these values. The result of this subtraction, minus the tare percentage of the package, is the change of weight resulting from the weight correction. The detection of change allows to find out whether a weight correction has actually been carried out in the case of a food portion, and how the food portion has been changed through the weight correction. Moreover, the weight of the respective weight correction may be subtracted from the weight value of the food portion determined by the end-of-line scale, so as to use the respective validated weight values for an advantageous statistical evaluation and for a feedback control of the slicing process.

The starting weight and/or the change of weight during the correction of the erroneous-weight food portion may be assigned to the data of this food portion and stored. Making use of this in-formation, the weight of the food portion measured by the end-of-line scale can be affiliated to the original weight of the food portion. The original weight of the weight-corrected food portion can then be assigned to the respective production track, without the evaluation or feedback control being corrupted.

In addition, also other changes may be detected, such as position corrections of the food portions in their entirety or of their slices relative to one another. The change of the food portions is detected by sensor means, in particular by optical means, and is advantageously assigned to the data concerning the respective food portion, and stored. Hence, it is possible to subject the subsequently modified food portions separately to statistical evaluation.

According to an embodiment, the food portions are packed in the course of multi-track conveying and they are optionally aligned in the conveying direction for this purpose. Thus, it is possible that the food portions are oriented with respect to the format set of a packaging machine. To this end, the food portions are arranged in spaced relationship with one another, especially in the conveying direction, the respective distances corresponding to the distances between the empty packages. The empty packages are in particular the bottom packaging trays of a thermoform packaging machine.

According to an advantageous embodiment, the positions of the food portions may be detected by sensors, in particular optically by means of at least one camera or at least one light barrier. The position detection allows tracking of the respective positions of the food portions. In particular, a plurality of the cameras or light barriers may be provided sequentially, each of said cameras or light barriers monitoring the respective positions of the food portions in an area of the production tracks.

When a camera is used as a sensor for tracking the food portions, especially image processing software which allows tracking of the food portions may be used. In particular, the area in which the food portions are moved between tracks may be monitored by a camera, especially the area in which the food portions are moved from the plurality of parallel production tracks to the reduced number of output tracks. In this way, it can be determined which of the food portions on the output track originate from which production track.

According to a further embodiment, a light signal projected onto a food portion or its package may be moved along therewith, the food portion being identifiable with the aid of the light signal. The light signal may especially be a light sign for identifying the food portion and the package, respectively, and/or it may provide information on at least one characteristic of the food portion or of the package of the latter.

The light signal may especially serve to request manual processing of the food portions, e.g., the addition or the removal of slices. According to some embodiments, the light signal may, however, also be detected by a sensor, in particular a camera. In this way, it can be communicated within the system that a food portion has specific characteristics, e.g., has been supplemented manually.

In particular, the light signal allows the food portion to be assigned to the respective production track during weight determination on the end-of-line scale.

According to an advantageous embodiment, the tracking of the food portions allows a portion-related exchange or transfer of information between the production track, e.g., the slicer or the checkweigher, and the end-of-line scale.

In addition, the tracking of the food portions allows a recording of deviations for the purpose of statistical evaluations for the respective production track, in particular as regards weight and weight deviations, position and optical features. Information which communicates deviations, in particular those exceeding a certain degree, may be outputted to the operator. Furthermore, an evaluation may take place in a batch-dependent manner and/or depending on the operating phase, after a change of parameters, in particular of the slicing process.

In addition, the food portions may be monitored, at least in subareas of their route over the production tracks and the output track, by means of a sensor, in particular an optical, capacitive or inductive sensor, so that changes at the food portions can be detected and/or recorded. The optical sensor is especially a camera, which allows such monitoring, in particular the detection and recording of changes at food portions in the process between the slicing and the removal of the packed and weighed food portions.

Especially, the position of the food portions in the package can be monitored. If a deviation of the desired condition is detected, a correction of the position may take place already on the production track, or the placing by means of a picker robot may be corrected. Monitoring of the position may be executed e.g., by laser scanning, in the course of which also the volume and quality criteria may be detected in addition to the position.

The position detected is compared with target settings and target parameters by the operator. To this end, setting aids may be provided. In particular, the position of the food portion may be captured with the camera of a picker robot, and may then be compared. Apart from that, other al-ready existing sensors may be used as well.

Portion monitoring may especially also be carried out in the area of the packaging machine, so that the position of the food portion in the respective package can be identified. Furthermore, it may be monitored by means of an optical system whether the food portion and its package are complete. In so doing, especially the number of slices of the food portion, the label of the pack-age and/or the print on the package can be detected. The optical system comprises one or a plurality of optical sensors, in particular cameras. Already existing systems or sensors may here be used over the entire line length by combining them and by integrating them into food portion tracking and/or position monitoring.

An embodiment is so conceived that, in the case of a detected deviation from target values concerning the arrangement, the external shape, the temperature and/or the slicing pattern of the food portions, an adapted feedback control of the slicing, arranging and/or precooling of the subsequent food portions will be executed. In this way, the quality, shape and weight of the produced food portions and of the package can positively be influenced in manifold ways.

An automatic adaptation of food portions in the process in response to detected deviations from target values concerning in particular the weight, the geometry, the temperature and the appearance of the individual slices or of the food portion can be carried out. The weight of the portions in the slicing process is adapted on the basis of the weight detected by the track-related scale and/or the end-of-line scale. The respective adaptation may be carried out in a track-related manner.

In addition, information, feedbacks and setting recommendations may be outputted to the operator as suggestions for setting the parameters of the system, in particular in readjustment processes, if limits that can be set in advance should be exceeded.

In particular, the geometry of a food portion can be improved by correcting the orientation of the individual slices by the portioner. Deviations with respect to temperature and appearance can be counteracted by adapting the precooling and by sorting out.

The present disclosure additionally provides a food processing system, comprising a food slicing system and a transfer apparatus, the food slicing system being configured to slice on a plurality of production tracks food products so as to form individual food portions, and the transfer apparatus being configured to transfer the food portions produced on a plurality of tracks to an output track. According to the present disclosure, a controller is provided, which is configured to assign, via an identification value, the respective food portions arranged on the output track to the respective production track and/or to a subsequent further-processing track, on which the food portion has been produced and/or treated, handled or processed.

The controller of the food processing system may consist of a separate higher-level controller, or of the controller of one of the components of the food processing system, in particular the controller of the food slicing system.

In particular, the controller comprises a data memory, in which a respective identification value is stored for each food portion arranged on the output track, said identification value allowing the respective food portion to be assigned to the production track on which the food portion has been produced and/or treated, handled or processed. In this way, the production, treatment, handling or processing of each food portion on the output track can be traced back to the production track. This not only allows advantageous monitoring of the system, but it also offers new and advantageous possibilities of controlling the system. The data memory may have stored therein further portion-specific data, e.g., which food product has been sliced for producing the respective food portion. To this end, especially an identification number of the food product, e.g., a serial number of the food product, may be stored in the data set of the food portion.

The data memory may be provided in the controller or in the network, e.g., in a data cloud.

The identification value may especially be a characterization value for the production track, e.g., a production track identification number.

Alternatively, the identification value may be a characterization value for the respective food portion, e.g., a food portion identification number. In particular, the data memory of the controller comprises a relational database, in which a data set is stored for each food portion, the identification value being the (unequivocal) key of the data set, and the additional characteristics of the food portion, in particular the production track, being stored as attribute values. The data sets comprising at least the identification value and, optionally, a plurality of attribute values may be archived, or they may be stored in the data memory only for the period between the production of the food portion and its end-of-line inspection.

According to the present disclosure, it is known in the controller which food portion has been produced through which production track, and evaluations can be made in this respect. The statistical values may be displayed in particular on a display of the food processing system, so as to allow the operator an overview of the function of the production tracks.

The food portion may, via the identification value, also be assigned to a further-processing track following after the production tracks. To this end, this information will be stored in a suitable manner in the data memory of the controller.

In particular, an end-of-line scale is provided, which is configured to determine the weight of the individual food portions on the output track. The controller is advantageously configured to assign the determined weight via the identification value to the respective production track. The end-of-line scale is especially arranged on the output track. Due to the fact that the food portions can be assigned to the production tracks, the end-of-line scale allows the determination of the average value of the portion weight of a specific batch size of food portions of a production track.

According to an advantageous embodiment, the controller is configured to control the slicing process of the plurality of production tracks separately, depending on the weight of the food portions assigned to the respective production track by the controller, said weight being determined on the end-of-line scale. This means that, although the weight of the food portions is determined on a common output track, a track-related feedback control can be executed due to the fact that the food portions can be assigned to the production tracks.

In particular, common conveyor belts or carrier belts may, at least in certain areas, be provided for multi-track conveyance of food portions. Advantageously, however, respective separately controllable conveyors are, at least in certain areas, provided for each production track.

This allows the food portions on the production tracks to be oriented relative to one another, so that they can be arranged in accordance with the requirements of a format set of a packaging machine. In addition, this will also be advantageous insofar as the production on the individual production tracks can be adapted depending on the respective boundary conditions, e.g., in the case of product changes in the food processing system.

According to an embodiment, a multi-track magnetic type linear conveyor is provided, which comprises individually controllable transport movers for multi-track conveying of the food portions. Each transport mover has here arranged thereon at least one food portion, so that the at least one food portion can be conveyed independently. A high flexibility of food portion conveyance can be accomplished in this way.

According to an advantageous embodiment, a portion carrier for the food portions is provided, which comprises an identification means. The identification means may e.g., be a number, a character, a barcode or an RFID chip.

The production track of the respective food portion can e.g., be read directly from the identification means. To this end, the portion carriers of a production track may each be provided with the same identification means.

Alternatively, the identification means may be adapted for reading therefrom an identification number for the respective food portion, viz. either an unequivocal key for the food portion or a characterization value for the portion carrier, which is linked as an attribute value to the identification value in the data memory.

The portion carrier is arranged in particular on the conveyor, e.g., on a conveyor belt, a carrier belt or on a transport mover. An identification means may e.g., be provided on an interleaver paper that is arranged below or between two food slices, as known from WO 2016/150641 A1.

According to an advantageous embodiment, the controller is configured to monitor the control of the transfer apparatus and, possibly, of further conveying systems, so as to track in this way the assigning of the individual food portions to the production tracks. The control of the transfer apparatus determines when and from which production track at least one food portion is transferred to the output track. Hence, it can be determined from this information from which production track a food portion, which is arranged on the output track, originates. This information can be stored in the data memory of the controller as an identification value or as an attribute value assigned to the latter.

According to an embodiment, track-related scales are provided upstream of the transfer apparatus. These scales are in particular checkweighers, which each determine the weight of the produced food portions individually, and feed said weight advantageously back to the food slicing system, so that a track-related weight control can take place. Furthermore, the weight information of the track-related scales may be used for sorting out or marking erroneous-weight portions.

According to an advantageous embodiment, the food slicing system may be a multi-track food slicing machine. A multi-track food slicing machine is e.g., a slicer, in which a plurality of food products are fed in parallel to a cutting knife. The feeding speed of the individual food products may here be controlled or feedback controlled separately. In addition, the multi-track food slicing machine may be a slicer comprising a plurality of knives in only one machine frame, so that slicing can be carried out in parallel with a plurality of knives. Each knife has simultaneously fed thereto one or a plurality of food products.

According to another embodiment, the food slicing system comprises a plurality of parallel single-track or multi-track food slicing machines, i.e., the food slicing system may be defined by a plurality of separate slicers which are arranged in parallel.

According to an embodiment, two or more output tracks are each provided with an end-of-line scale, i.e., the transfer apparatus transfers the food portions produced on a plurality of tracks to a respective one of the plurality of output tracks. Also in this case, each food portion is adapted to be tracked via an identification value in the data memory of the controller, so that it will be possible to assign the respective food portion to its production track.

A plurality of output tracks will be advantageous e.g., insofar as the products can be packed separately and, optionally, in different packages. For example, all the products of a quality class may be packed in a first packaging machine, and all the products of a second quality class may be packed in a second packaging machine, the weight of each of the packed products being checked by the respective end-of-line scale.

According to an embodiment, the transfer apparatus comprises a transition conveyor with a guide unit, the transition conveyor being configured to arrange the food portions of a plurality of tracks sequentially one after the other in the conveying direction on the output track. The guide unit may in particular be a guide slope, but a guide curve may be used as well.

According to another embodiment, the transfer apparatus comprises one or a plurality of transition conveyors, which are adapted to be displaced in a direction transversely to the conveying direction, or to be pivoted, so as to take up food portions from a plurality of tracks and advance them sequentially onto the output track. This can be done, e.g., by conveyors which are adapted to be displaced in a transverse direction, in particular by conveyor belts or carrier belts.

According to an advantageous embodiment, the transfer apparatus comprises a picker robot for gripping food portions from a plurality of tracks and depositing them sequentially on the at least one output track. To this end, especially a 3D delta robot is provided. Alternatively, also a 2D delta robot or a gantry robot may be provided. During moving of the portions from the plurality of tracks, the transverse and/or longitudinal movement of the food portion during the moving process is evaluated, and trackability is made possible through the stored identification value.

Furthermore, also the moving of the food portion into the package by means of a picker robot may be stored in the data memory in a suitable data format per food portion. An identification value, which had already been stored before the food portion was placed into the package, can be maintained.

In particular, the position coordinates and/or positions of the respective food portions on the plurality of tracks are detected, and also the moving into the package by means of the robot is stored and/or evaluated as regards position and location.

The robot is in particular a multi-axis robot. The transfer movement described in the preceding embodiment is advantageous especially with respect to a format set completion, with the trackability of the food portion being maintained.

According to an embodiment, an auxiliary track is provided, onto which food portions are discharged from a certain erroneous weight onwards, the auxiliary track being configured such that the weight of food portions can be corrected thereon by adding or removing food slices. The information indicating that a weight correction has been carried out and/or the amount by which the weight of the food portion has been corrected, may be stored in the data memory of the controller in the data set of the respective food portion.

Erroneous-weight means that the weight in question lies either above or below a certain limit weight. In particular, a discharge device is provided downstream of the track-related scales. The discharged food portions are, via their identification value, identified as having been discharged. In addition, it may be stored in the data memory of the controller, whether a food portion has been weight-corrected by an addition or by a removal. After the weight correction, the discharged food portions may be returned onto the production tracks or directly onto the output track.

According to an advantageous embodiment, the data memory of the controller has stored there-in, in addition to the identification value for the food portion and/or an identification value for the food product from which the food portion has been sliced, characteristics of the respective food portion and/or food product. The characteristics may comprise, among other values, the weight, the position and/or optical features of the food portions, which may be evaluated statistically. This allows recording in the data memory of the controller.

According to alternative embodiments, only an identification value is stored in the data memory of the controller, and values relating to this identification value are stored in the respective local memories of the individual devices, such as the track-related scales, the end-of-line scale, the transfer apparatus, etc. This information relating to a food portion can be retrieved by the central controller, and is thus available throughout the system.

Embodiments according to the present disclosure will now be explained making reference to the attached figures.

### BRIEF DESCRIPTION OF THE DRAWINGS

FIG. 1 shows a top view of an embodiment of a food processing system according to the present disclosure;

FIG. 2 shows a top view of a first alternative embodiment of a transfer apparatus in a food processing system according to the present disclosure;

FIG. 3 shows a top view of a second alternative embodiment of a transfer apparatus in a food processing system according to the present disclosure;

FIG. 4 shows a top view of a third alternative embodiment of a transfer apparatus in a food processing system according to the present disclosure; and

FIG. 5 shows a top view of a fourth alternative embodiment of a transfer apparatus in a food processing system according to the present disclosure.

### DETAILED DESCRIPTION

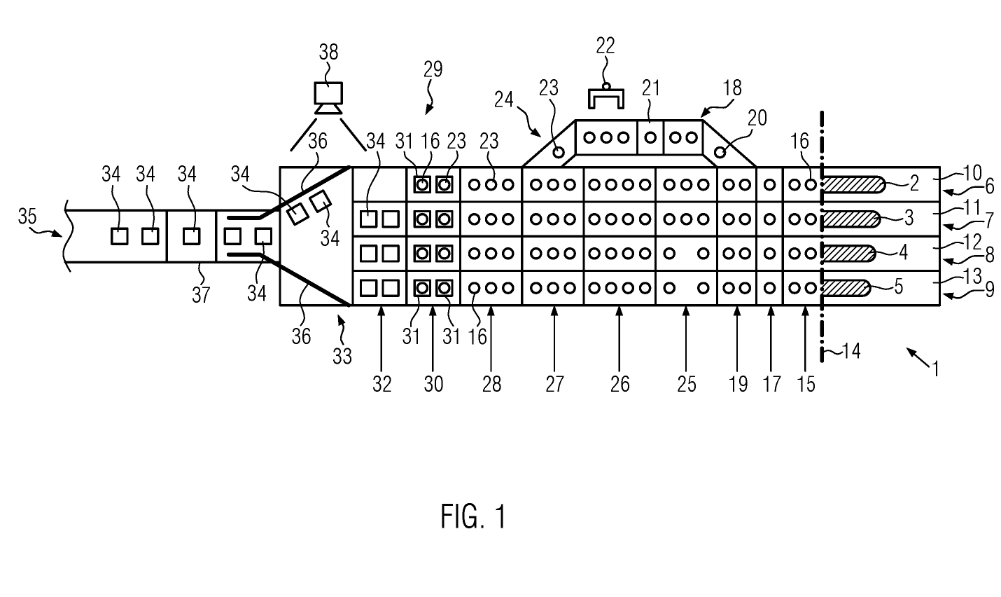

The embodiment of the food processing system according to FIG. 1 comprises a food slicing system 1 in the form of a multi-track slicer, in which a plurality of food products 2, 3, 4, 5 are sliced on parallel production tracks 6, 7, 8, 9. To this end, the food products 2, 3, 4, 5 are fed, by means of individually controllable feeding tracks 10, 11, 12, 13, to a slicing plane 14 in which one or a plurality of knives rotate.

The food slices cut off from the food products are deposited on a portioner 15 until they form a desired food portion 16. By moving the portioner 15, the arrangement of the food slices relative to one another in the portion can be produced, e.g., a shingled mode of arrangement.

The food portions 16 are advanced on the respective production track 6, 7, 8 or 9 to a track-related scale 17, in particular a throughput checkweigher. For each individual production track 6, 7, 8, 9, a track-related scale 17 is provided, which is capable of determining the weight of the respective food portions 16 on this track. The track-related scales 17 may be arranged together in an integral scales system, in particular a multi-track checkweigher.

The weight of the food portions 16 determined by track-related scales 17 may, within the frame-work of a feedback control, be fed back to the food slicing system, where it can be taken into account in the feedback control of the slicing process. In particular, if the weights of the food portions 16 should be too low, the slice thickness can be increased. This is normally done by increasing the feed rate of the feeding tracks 10, 11, 12, 13. In the case of excessively high portion weights, the slice thickness can be reduced.

If, in spite of this track-related feedback control, food portions should be produced, which fail to reach or which exceed a certain minimum value or maximum value, these food portions will be discharged onto an auxiliary track 18. To this end, a discharge device 19 is provided, in which food portions 16 can be discharged from the production tracks 6, 7, 8, 9 onto the auxiliary track 18, e.g., by a rocker, a conveyor belt operating in a transverse direction or a picker robot. It is also possible to discharge food portions, which do not satisfy optical criteria, a circumstance that can be detected e.g., by means of an optical sensor, in particular a camera, in the area of the production tracks.

The discharge device 19 is operated by a controller, in which also the results of the track-related scales 17 are stored. On the auxiliary track 18, a correction of the discharged food portions 20 may take place, in particular by adding or removing slices.

According to the present embodiment, the auxiliary track 18 comprises a scale 21, which allows an operator 22 to correct the weight of the food portions. In particular, it is displayed to the operator 22 how many slices or which weight he will have to add or remove.

The weight-corrected food portions 23 can then be returned onto the production tracks 6, 7, 8, 9 by means of an infeed device 24, in particular a rocker, a conveyor belt operating in a transverse direction or a picker robot.

The production tracks 6, 7, 8, 9 additionally comprise a format completing device 25, in which respective food portions 16 are collected so as to complete a format set.

Subsequently, they are transferred to a portion aligner 26, in which the portions are aligned at predetermined distances.

Alternatively or additionally to the auxiliary track 18, a portion indicator 27 may be provided, which provides an area where it is indicated to the operator how erroneous-weight portions are to be corrected. To this end, e.g., an indicator may be provided, which indicates, in a form identifiable by the operator, which food portions have to be supplemented or reduced in which way. This may take place by a separate display, by illuminated-sign arrays or by projecting a light signal directly onto the food portions 16 or onto a point next to the latter.

The food portions 16 and the weight-corrected food portions 23 are jointly conveyed on a transfer conveyor 28 to a packaging machine 29, in particular a thermoform packaging machine. There, the food portions 16, 23 are first fed into bottom packaging trays 31, which are then sealed in a sealing apparatus 32.

As can be seen in the present embodiment, the respective non-weight-corrected food portions 16 remain on their production track. A change of production tracks can only take place by a discharge of food portions 20, which are then re-introduced as weight-corrected food portions 23, possibly onto a different production track.

The controller of the food processing apparatus communicates with the respective controllers of the discharge device 19 and of the infeed device 24, and will thus be able to monitor where a food portion is discharged and fed in. According to the present disclosure, the controller has provided therein a data memory, in which a respective identification value is stored for the food portion, so that the latter can be identified. This allows tracking of the position of the individual food portions. Furthermore, it can be detected in the controller which food portions have been supplemented, reduced or corrected in some other way, and this can be stored in the controller as an attribute value to a data set for each food portion.

Downstream of the packaging machine 29, the food processing apparatus comprises a transfer apparatus 33 by means of which the packed food portions 34 are guided onto an output track 35 and combined thereon. To this end, a guide slope 36 may especially be provided. On the output track 35, an end-of-line scale 37 is provided, by means of which the individual weights of the respective packed food portions 34 can be weighed separately.

In order to allow the food portions 16, 23, 34 to be tracked, an optical sensor, in particular in the form of a camera 38, is provided, which monitors the movement of the individual packed food portions 34 in the area of the transfer apparatus 33 and determines which packed food portion 34 originates from which production track 6, 7, 8, 9.

The weight value measured by the end-of-line scale 37 can thus be assigned to a respective one of the production tracks 6, 7, 8, 9, or it can be determined that the packed food portion 34 on the end-of-line scale 37 is a weight-corrected food portion 23.

According to the present embodiment, the weight values of all the uncorrected food portions 16 or values derived therefrom are fed back for feedback controlling the food slicing system in the respective production track. This can be done especially by forming an average value over a certain batch size of packed food portions 34 from a production track 6, 7, 8 or 9. If this average value lies above the desired average weight value, the slice thickness on the respective production track of the food slicing system 1 may be reduced. If the average weight value lies below the desired average weight value, the slice thickness may be increased.

The transfer apparatus 33 is operated in particular as follows: the food portions 16, 23 are fed to a funnel from the individual production tracks 6, 7, 8, 9 in a controlled and feedback controlled manner, the funnel being defined by the guide slopes 36 above a transition conveyor. In so doing, the number of food portions of the respective production tracks 6, 7, 8, 9 fed to the transfer apparatus 33 is precisely feedback controlled. For example, a predetermined number of food portions from the first production track 6 may first be fed to the transfer apparatus 33. The number of transferred food portions corresponds to the preferred number of food portions of a format set of the packaging machine 29.

Subsequently, the food portions of the further production tracks 7, 8, 9 of the format set are successively transferred to the transfer apparatus 33. The transfer apparatus 33 comprises a transition conveyor in the form of a conveyor belt, whose width corresponds at least to the width of a side-by-side arrangement of all the production tracks 6, 7, 8, 9. Above the transition conveyor, guide slopes 36 are arranged on both sides, so that the conveying area tapers towards the output track 35. In this way, all the food portions 34 are guided onto a single output track 35.

The output track 35 is defined by a single-track conveyor belt, which feeds the packed food portions to the end-of-line scale 37. The latter determines the individual weights of the food portions including the package and possible interleaver films or supports, in particular L-boards.

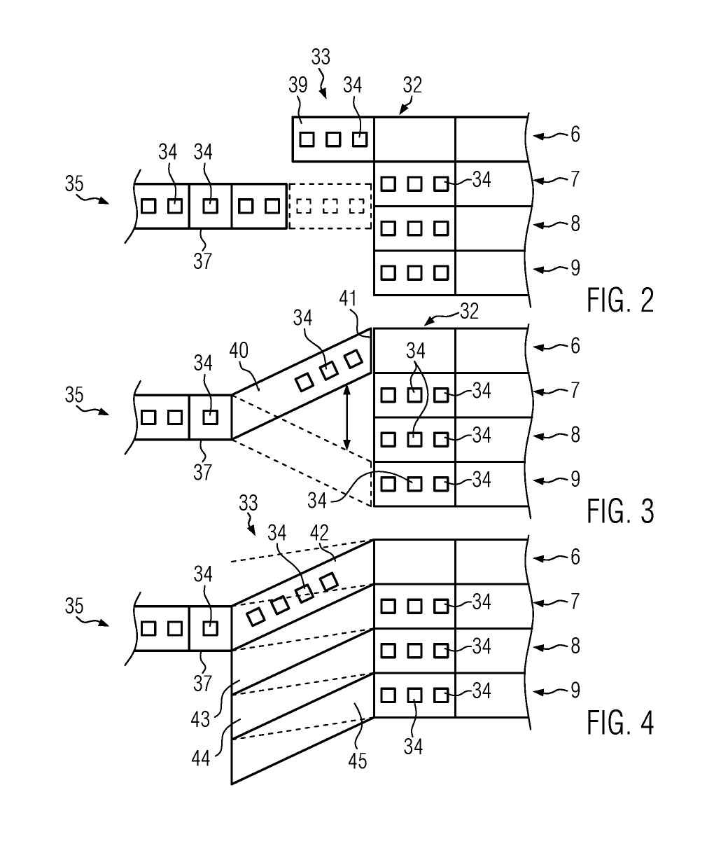

In the embodiment according to FIG. 2, the transfer apparatus 33 is configured as a single-track, parallel-displaceable transition conveyor 39, which is adapted to be displaced transversely to the conveying direction of the production tracks 6, 7, 8, 9. As shown in FIG. 2, the transition conveyor 39 is first aligned with the first production track 6. Subsequently, the packed food portions 34 of a format set are arranged thereon. Following this, the transition conveyor 39 is moved in a transverse direction until it has been brought into alignment with the output track 35, as shown by broken lines. Then, the packed food portions 34 are transferred from the transition conveyor 39 to the output track 35, where their weight is checked individually by the end-of-line scale 37. This process is then also executed starting from the other production tracks 7, 8, 9, so that all the packed food portions 34 are combined on the output track 35. The transition conveyor 39 is in particular a conveyor belt.

The controller of the transfer apparatus 33 communicates with the controller of the food processing system, so that it can be determined which food portions 34 from which production tracks 6, 7, 8, 9 are transferred to the output track 35.

Alternatively, however, also a parallel-displaceable transition conveyor comprising a plurality of tracks can be used. In this way, it will especially be possible that on one track of the transition conveyor food portions are taken up from one of the production tracks 6, 7, 8, 9, while, simultaneously, food portions are transferred to the output track 35 from some other track of the transition conveyor. Alternatively, food portions from a plurality of production tracks 6, 7, 8, 9 may simultaneously be taken up on a plurality of tracks of the transition conveyor, and may then be transferred to the output track 35.

In this context, it is also possible that each of a plurality of output tracks is provided with an end-of-line scale.

FIG. 3 shows a further embodiment of a transfer apparatus 33. The transfer apparatus 33 comprises a transition conveyor 40, which is displaceable only on the upstream input side, whereas the downstream side continuously adjoins the output track 35. By displacing the input side 41, i.e., by pivoting the transition conveyor 40, the packed food portions 34 can be taken up from all the production tracks 6, 7, 8, 9 and combined on the output track 35. By evaluating the controller and/or monitoring the transfer apparatus 33, it is again possible to determine from which production tracks 6, 7, 8, 9 the respective food portions 34 originate. During operation, whole format sets of food portions are again transferred sequentially from the production tracks 6, 7, 8, 9 to the output track 35.

In particular, the transition conveyor 40 is configured as a single-track conveyor belt, which is displaceable transversely on the input side. To this end, especially an elasticity of the conveyor belt or a length compensation device may be provided, which allows the conveyor belt to directly adjoin the production tracks 6, 7, 8, 9 also in the case of the outer production tracks 6, 7, 8, 9. Alternatively, the production tracks may be configured such that they are slightly longer in the outer area, so that they directly adjoin the transition conveyor 40. In other embodiments, the transition conveyors are arranged below the production tracks 6, 7, 8, 9 in certain areas thereof.

FIG. 4 shows a further embodiment of the transfer apparatus 33, in which a transition conveyor 42, 43, 44, 45 is provided downstream of each production track 6, 7, 8, 9. Each of the transition conveyors 42, 43, 44, 45 is, at least on its downstream side, displaceable in a transverse direction or pivotable, so that a respective one of the transition conveyors 42, 43, 44, 45 can be brought into alignment with the output track 35. Subsequently, the packed food portions 34 arranged on the transition conveyor in question are advanced onto the output track 35.

In particular, a transverse displaceability may be provided instead of the pivotability. In this way it is possible that a plurality of parallel transition conveyors in the form of transition conveyor belts are transversely displaceable, so that each of the conveying tracks can be positioned in directly opposed relationship with the output track 35 and the packed food portions can be conveyed to the end-of-line scale 37.

In all the embodiments, the respective control of the transfer apparatus 33 can be monitored, so that it can be determined which food portions from which production tracks 6, 7, 8, 9 have been moved onto the output track 35, so that, when the weight is being checked by the end-of-line scale 37, the weight value can be assigned to a respective production track 6, 7, 8, 9, provided that the portion has not been weight-corrected.

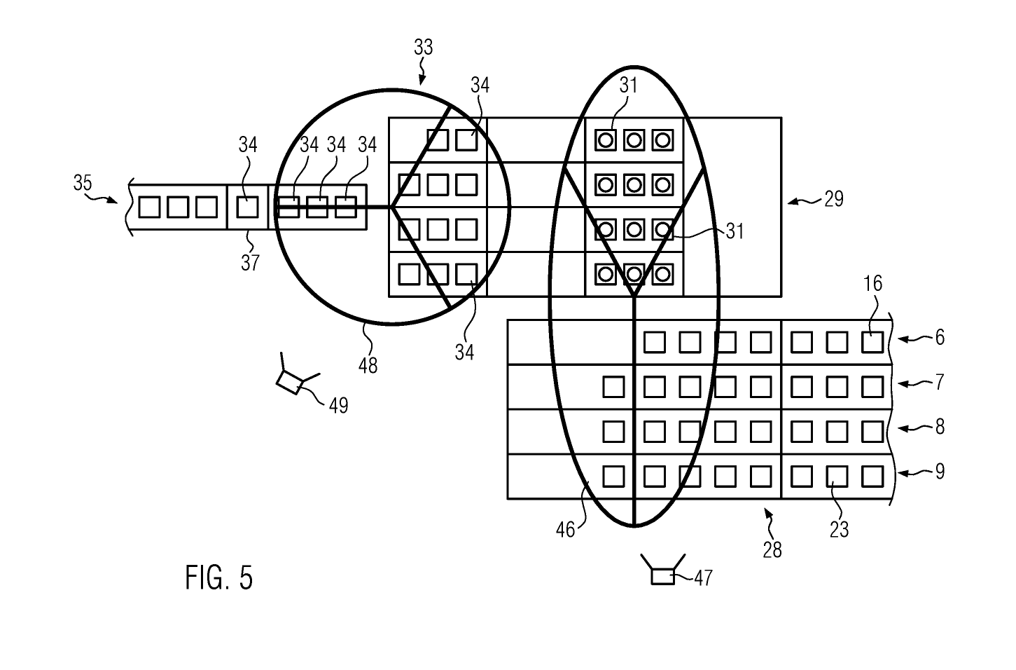

FIG. 5 shows a further development of the packaging machine 29 and of the transfer apparatus 33 in an embodiment of a food processing apparatus according to the present disclosure. The respective food portions 16 and weight-corrected food portions 23 are conveyed on a transition conveyor 28 to a first picker robot 46, which grips the food portions 16, 23, displaces them transversely towards the packaging machine 29 and feeds them there into the bottom packaging tray. The number of tracks in the food packaging apparatus may differ from the number of production tracks 6, 7, 8, 9.

The movements of the individual food portions 16, 23 may here be retraced either on the basis of the control of the picker robot 46 and/or by means of a camera 47. The image captured by the camera 47 allows tracking of the food portions 16, 23 by means of an image processing software.

The packaging machine 29 is, in particular, a thermoform packaging machine, in which the bottom packaging trays 31 are closed by sealing with a film.

The packed food portions 34 are then advanced on a plurality of tracks of the packaging machine 29 and gripped by means of a second picker robot 48, whereupon they are moved onto the output track 35, where they are weighed individually by means of an end-of-line scale 37. In the course of this process, the control of the second picker robot 48 is monitored. By uniting the information on the moving process of the first picker robot 46 and on the moving process of the second picker robot 48 it can then be retraced from which production track 6, 7, 8, 9 a respective packed food portion 34 originates. On the basis of the weight value detected by the end-of-line scale 37, the feedback control of this production track can be adapted precisely. Also for the moving process of the second picker robot 48 a camera 49 may be provided alternatively or additionally, the position of the individual packed food portions 34 being then retraced by means of image processing and tracking.

As one skilled in the art would understand, the above-described controller and any other system, subsystem, apparatus, device or module described herein may individually, collectively, or in any combination comprise appropriate circuitry, such as one or more appropriately programmed processors (e.g., one or more microprocessors including central processing units (CPU)) and associated memory, which may include stored operating system software and/or application software executable by the processor(s) for controlling operation thereof and for performing the particular algorithms represented by the various functions and/or operations described herein, including interaction between and/or cooperation with each other. One or more of such processors, as well as other circuitry and/or hardware, may be included in a single ASIC (Application-Specific Integrated Circuitry), or several processors and various circuitry and/or hardware may be distributed among several separate components, whether individually packaged or assembled into a SoC (System-on-a-Chip).

What is claimed is:

1. A method for processing food products, the method comprising:
a) multi-track slicing of food products into individual food portions on a plurality of production tracks;
b) detecting at least one feature of a food portion during and/or after slicing;
c) multi-track conveying of the food portions on separate production tracks;
d) moving the food portions from a plurality of production tracks onto at least one output track and/or moving them between different tracks and/or grouping them; and
e) tracking position of the individual food portions by means of a controller, so that, for each food portion which has been moved onto the at least one output track, it is known on which production track the food portion has been produced.

2. The method according to claim 1 further comprising monitoring of the individual food portions by means of monitoring units, so that, for each food portion which has been moved onto the at least one output track, it will be known which features the food portion has and/or which changes the food portion has undergone.

3. The method according to claim 1 further comprising measuring weight of the individual food portions on the at least one output track with an end-of-line scale, and assigning the weight measured on the end-of-line scale to the respective production track on which the food portion in question has been sliced.

4. The method according to claim 3 wherein slicing on the production tracks is separately feedback controlled based on the measured weight of the food portions of the respective production tracks or based on values derived therefrom, so that slice thickness or number of slices is adapted during the slicing.

5. The method according to claim 1 wherein a track-related average value of weight is formed over a specific number of food portions from a production track.

6. The method according to claim 3 wherein the food portions are weighed during step c) with respective track-related scales, wherein weight value of a food portion detected by the track-related scale is compared with the weight value of the same food portion on the end-of-line scale.

7. The method according to claim 1 wherein, during step c), the food portions are arranged relative to one another in a format set, and wherein, in so doing, food portions are transversely moved between the production tracks, the transverse moving being tracked by the controller.

8. The method according to claim 1 wherein weight of an erroneous-weight food portion is corrected during step c) by adding or removing food slices, wherein, when a weight correction for a food portion is executed, this weight correction is stored in a data memory in a portion-related manner.

9. The method according to claim 8 wherein change of the erroneous-weight food portion during weight correction is detected by a comparison between weight determined with a track-related scale and weight determined with an end-of-line scale before and after the weight correction.

10. The method according to claim 1 further comprising monitoring and storing moving of the food portions from a single-track or multi-track feed belt with transfer belts or robots onto or into open packaging trays.

11. The method according to claim 1 wherein in step d) positions of the food portions are detected by means of a camera or by means of light barriers, so as to track the individual food portions.

12. The method according to claim 1 wherein a light signal projected onto a food portion is moved along with the latter, and the food portion is identifiable with the aid of the light signal.

13. The method according to claim 1 wherein the food portions are monitored, at least in subareas of their route from the production tracks up to and including the at least one output track, by means of a sensor, so that changes at the food portions can be detected and/or recorded.

14. The method according to claim 1 wherein, in the case of detected deviations from target values concerning arrangement, external shape, temperature and/or slicing pattern of the food portions, an adapted feedback control of the slicing, arranging and/or precooling of the subsequent food portions will take place.

15. A food processing system comprising:
a food slicing system configured to slice on a plurality of production tracks food products so as to form individual food portions;
a transfer apparatus configured to transfer the food portions produced on multiple tracks of the plurality of production tracks to an output track; and
a controller, which is configured to assign, via a respective identification value, each food portion arranged on the output track to the respective production track on which the food portion has been produced and/or treated, handled or processed.

16. The food processing system according to claim 15 further comprising an end-of-line scale, which is configured to determine weight of the individual food portions on the output track, and wherein the controller is configured to assign the determined weight via the identification value to the respective production track.

17. The food processing system according to claim 16 wherein the controller is configured to control the slicing process on the plurality of production tracks separately, depending on the weight of the food portions assigned to the respective production track by the controller.

18. The food processing system according to claim 15 further comprising a multi-track magnetic type linear conveyor, which comprises individually controllable transport movers for multi-track conveying of the food portions.

19. The food processing system according to claim 15 further comprising a portion carrier for the food portions, which comprises an identification means.

20. The food processing system according to claim 15 wherein the controller is configured to monitor control of the transfer apparatus so as to track the assigning of the individual food portions to the production tracks.

21. The food processing system according to claim 15 further comprising track-related scales provided upstream of the transfer apparatus.

22. The food processing system according to claim 15 wherein the food slicing system is a multi-track food slicing machine.

23. The food processing system according to claim 15 wherein the food slicing system comprises a plurality of parallel single-track or multi-track food slicing machines.

24. The food processing system according to claim 15 wherein the food processing system includes two or more of the output tracks, and an end-of-line scale provided for each of the output tracks.

25. The food processing system according to claim 15 wherein the transfer apparatus comprises a transition conveyor with a guide unit, the transition conveyor being configured to arrange the food portions of a plurality of production tracks sequentially one after the other in the conveying direction on the output track.

26. The food processing system according to claim 15 wherein the transfer apparatus comprises one or a plurality of transition conveyors, which are adapted to be displaced in a direction transversely to the conveying direction, or to be pivoted, so as to take up food portions from a plurality of tracks and advance them sequentially onto the output track.

27. The food processing system according to claim 15 wherein the transfer apparatus comprises a robot for gripping food portions from a plurality of tracks and depositing them sequentially onto the output track.

28. The food processing system according to claim 15 further comprising an auxiliary track onto which food portions are dischargeable from a certain erroneous weight onwards, the auxiliary track being configured such that weight of food portions can be corrected thereon by adding or removing food slices.

29. The food processing system according to claim 15 wherein the controller comprises a data memory having stored therein, in addition to the identification value for each food portion, characteristics of each food portion including weight, position and/or optical features, which may be evaluated statistically.
